(19) United States
(12) Patent Application Publication
(10) Pub. No.: US 2009/0271413 A1
(43) Pub. Date: Oct. 29, 2009

(54) TRIAL LISTENING CONTENT DISTRIBUTION SYSTEM AND TERMINAL APPARATUS

(75) Inventors: Keiichiro Hoashi, Fujimino-shi (JP); Hiromi Ishizaki, Fujimino-shi (JP); Chihiro Ono, Fujimino-shi (JP)

Correspondence Address: MITCHELL P. BROOK;LUCE, FORWARD, HAMILTON & SCRIPPS LLP, 11988 EL CAMINO REAL, SUITE 200, SAN DIEGO, CA, 92130, US

(73) Assignee: KDDI Corporation, Tokyo (JP)

(21) Appl. No.: 12/431,647

(22) Filed: Apr. 28, 2009

(30) Foreign Application Priority Data
Apr. 28, 2008 (JP) P2008-117050

(51) Int. Cl. G06F 17/30; G06Q 10/00; G06N 5/02

(52) U.S. Cl. 707/10; 705/10; 705/30; 706/54

(57) ABSTRACT

The present invention provides a content distribution system capable of improving user convenience and effectively distributing content for trial listening. A terminal apparatus includes: a content database that stores plural kinds of content data for trial listening received from a content distribution server; a usage history information recording unit that records usage history information of a user; a user preference estimating unit that estimates user preference on the basis of the usage history information of the user recorded in the usage history information recording unit, and generates preference information; a content extracting unit that calculates similarity between the preference information and each of the content data for trial listening stored in the content database, and extracts content data for trial listening having high similarity from the content database; and a content data playing unit that plays the extracted content data for trial listening.

### BACKGROUND OF THE INVENTION

1. Field of the Invention

The present invention relates to a trial listening content distribution system in which a portable terminal apparatus receives plural kinds of content data for trial listening from a content distribution server and plays one of the received content data for trial listening.

2. Description of the Related Art

A music distribution server capable of providing a service for allowing a user to listen to a chorus part of music before purchasing it has been known in the related art. In the service, when the user selects desired music, a voice source for trial listening of the selected music is played. Then, when the user is pleased with the music, the user can purchase it.

Japanese Patent Application Laid-Open No. 2001-282258 (Patent Document 1) discloses a system (playing control method) that adds various conditions, such as a trial listening period, to content for trial listening and distributes the content. In addition, Japanese Patent Application Laid-Open No. 2003-022079 (Patent Document 2) discloses a technique that distributes content from a content distribution apparatus to a portable terminal by near field communication in a public place. This technique is characterized in that the portable terminal is guided within the range of the distribution apparatus. Further, Japanese Patent Application Laid-Open No. 2006-040100 (Patent Document 3) discloses a trial listening system for rental CD shop members. In the system, a member presents a membership card to borrow a portable terminal for listening to music for trial listening. A trial listening history is registered in the portable terminal. In this way, a system manager can effectively acquire the trial listening history of the member.

Furthermore, Japanese Patent Application Laid-Open No. 2006-040467 (Patent Document 4) discloses a system that sets an available period to a trial listening portable terminal such that the user can carry it out of the store. In addition, Japanese Patent Application Laid-Open No. 2006-079179 (Patent Document 5) discloses a technique that enables a player to listen to content for trial listening with a trial listening player at any time and to purchase it at a desired time. Japanese Patent Application Laid-Open No. 2001-028786 (Patent Document 6) discloses a technique in which a portable terminal receives and plays music content (for trial listening) and, when a user is pleased with the music content, the user can purchase it.

A service has been known in which a “program” created by a content provider is distributed to a plurality of portable user terminals. This service can be considered as a music trial listening service in that the user accesses information inserted into the program to purchase music used in the program. In addition, a known digital recorder has a function of recording a large number of television programs corresponding to a keyword (for example, a genre or an actor name) designated by the user and provides the programs to the user. This function makes it possible for the user to record a desired television program without designating the program whenever the user records the television program.

However, in the music trial listening function of the music distribution service according to the related art, the user needs to select desired content for trial listening. Therefore, this function is inconvenient, and it is difficult to find new music. In the techniques disclosed in Patent Documents 1 to 4, the user needs to go to the place where the trial listening terminal is provided (for example, a rental DVD shop) in order to listen to music for trial listening, which is inconvenient. In the techniques disclosed in Patent Documents 5 and 6, since the portable terminal is used, the user can listen to music for trial listening at any time. However, the user needs to manually select (search) desired content for trial listening, which is inefficient.

In the program distribution service, since music for trial listening that the user wants to listen to is not necessarily distributed, user convenience is lowered. In addition, a content provider needs to create programs (music composition) attractive to the user, which results in an increase in cost. As a result, it is difficult to create and distribute programs suitable for individual user preference. In a method of accumulating a large amount of contents to a recorder having a large number of media and allowing a user to select desired content from the accumulated contents, the user needs to select interesting content from a large amount of accumulated contents, and user convenience is lowered. As a rule, only content corresponding to the conditions designated by the user is accumulated. Therefore, it is difficult for the user to find unknown content.

The invention has been made in order to solve the above-mentioned problems, and an object of the invention is to provide a trial listening content distribution system and a terminal apparatus capable of improving user convenience and effectively distributing content for trial listening.

### BRIEF SUMMARY OF THE INVENTION

According to an aspect of the invention, a trial listening content distribution system includes a terminal apparatus and a content distribution server. The terminal apparatus receives plural kinds of content data for trial listening from the content distribution server, and plays one of the received content data for trial listening. The terminal apparatus includes: a content database that stores the plural kinds of received content data for trial listening; a usage history information recording unit that records usage history information of a user; a user preference estimating unit that estimates user preference on the basis of the recorded usage history information of the user, and generates preference information; a content extracting unit that calculates similarity between the generated preference information and each of the content data for trial listening stored in the content database, and extracts content data for trial listening having high similarity from the content database; and a content data playing unit that plays the extracted content data for trial listening.

As such, user preference is estimated on the basis of the usage history information of the user, and preference information is generated. Then, the similarity between the generated preference information and each of the content data for trial listening stored in the content database is calculated, and content data for trial listening having high similarity is extracted from the content database. Therefore, it is possible to effectively distribute content for trial listening that is suitable for individual user preference. In addition, it is possible to play content data for trial listening without the setting of conditions by the user. Therefore, it is possible to improve user convenience. Further, it is possible to provide unknown content for trial listening to the user. Therefore, it is possible to provide a chance to purchase new content to the user, which is unavailable in the related art. Furthermore, a mobile phone can be used as the terminal apparatus. Therefore, there are no restrictions in place and it is possible to improve user convenience.

### BRIEF DESCRIPTION OF THE DRAWINGS

FIG. 1 a diagram schematically illustrating the structure of a content distribution system according to an embodiment of the invention;

FIG. 2 is a diagram illustrating an example of a screen displayed on a portable terminal apparatus; and

FIG. 3 is a diagram illustrating a modification of the content distribution system according to the embodiment.

### DETAILED DESCRIPTION OF THE INVENTION

According to an embodiment of the invention, a trial listening content distribution system includes a terminal apparatus and a content distribution server. The terminal apparatus receives plural kinds of content data for trial listening from the content distribution server, and plays one of the received content data for trial listening. The terminal apparatus includes: a content database that stores the plural kinds of received content data for trial listening; a usage history information recording unit that records usage history information of a user; a user preference estimating unit that estimates user preference on the basis of the recorded usage history information of the user, and generates preference information; a content extracting unit that calculates similarity between the generated preference information and each of the content data for trial listening stored in the content database, and extracts content data for trial listening having high similarity from the content database; and a content data playing unit that plays the extracted content data for trial listening.

As such, user preference is estimated on the basis of the usage history information of the user, and preference information is generated. Then, the similarity between the generated preference information and each of the content data for trial listening stored in the content database is calculated, and content data for trial listening having high similarity is extracted from the content database. Therefore, it is possible to effectively distribute content for trial listening suitable for individual user preference. In addition, it is possible to play content data for trial listening without the setting of conditions by the user. Therefore, it is possible to improve user convenience. Further, it is possible to provide unknown content for trial listening to the user. Therefore, it is possible to provide a chance to purchase new content to the user, which is unavailable in the related art. Furthermore, a mobile phone can be used as the terminal apparatus. Therefore, there are no restrictions in place and it is possible to improve user convenience.

In the trial listening content distribution system according to this embodiment, the terminal apparatus further includes: a purchase content selecting unit that is operated by the user to generate purchase content information indicating that the user purchases one of the content data for trial listening extracted by the content extracting unit, or content corresponding to the content data for trial listening currently being played by the content data playing unit or the content data for trial listening played by the content data playing unit; and a purchase content information transmitting unit that transmits the purchase content information to the content distribution server.

As such, the purchase content information indicating that the user purchases one of the extracted content data for trial listening, or content corresponding to the content data for trial listening currently being played or the played content data for trial listening is generated, and the purchase content information is transmitted to the content distribution server. Therefore, for example, when the user listens to content data for trial listening, the user can purchase it.

In the trial listening content distribution system according to this embodiment, the usage history information of the user includes at least one of a content purchase history, a content playing history, and a function registration history related to the setting of content playing.

As such, the usage history information of the user includes at least one of the content purchase history, the content playing history, and the function registration history related to the setting of content playing. Therefore, when the user uses the terminal apparatus to perform an operation related to content, the history of the operation is registered, which can be then used to select content data for trial listening. In this way, it is possible to effectively distribute content for trial listening that is suitable for individual user preference. In addition, it is possible to play content data for trial listening without the setting of conditions by the user. Therefore, it is possible to improve user convenience. Further, it is possible to provide unknown content for trial listening to the user. Therefore, it is possible to provide a chance to purchase new content to the user, which is unavailable in the related art.

In the trial listening content distribution system according to this embodiment, the content data for trial listening may be music data for trial listening. The content extracting unit calculates the similarity between the generated preference information and each of the music data for trial listening stored in the content database on the basis of meta information added to the music data for trial listening, the amount of acoustic characteristics extracted from the music data, or a combination thereof.

According to the above-mentioned structure, it is possible to extract music data corresponding to user preference. As a result, it is possible to play music data for trial listening suitable for individual user preference. In addition, it is possible to play music data for trial listening without the setting of conditions by the user. Therefore, it is possible to improve user convenience. Further, it is possible to provide unknown music data for trial listening to the user. Therefore, it is possible to provide a chance to purchase new content to the user, which is unavailable in the related art.

In the trial listening content distribution system according to this embodiment, the content distribution server includes: a storage unit that stores plural kinds of content data for trial listening; a content classifying unit that classifies the stored content data for trial listening into a plurality of categories; and a content transmitting unit that transmits the content data for trial listening classified into the plurality of categories to the terminal apparatus. The content database stores the content data for trial listening classified into the plurality of categories and transmitted from the content distribution server. The content extracting unit extracts content data from one of the categories designated by the user.

As such, since the content distribution server classifies the stored content data for trial listening into a plurality of categories, the terminal apparatus can effectively extract content data corresponding to user preference.

According to another embodiment of the invention, there is provided a terminal apparatus that receives plural kinds of content data for trial listening from a content distribution server and plays one of the received content data for trial listening. The terminal apparatus includes: a content database that stores the plural kinds of received content data for trial listening; a usage history information recording unit that records usage history information of a user; a user preference estimating unit that estimates user preference on the basis of the recorded usage history information of the user, and generates preference information; a content extracting unit that calculates similarity between the generated preference information and each of the content data for trial listening stored in the content database, and extracts content data for trial listening having high similarity from the content database; and a content data playing unit that plays the extracted content data for trial listening.

As such, user preference is estimated on the basis of the usage history information of the user, and preference information is generated. Then, the similarity between the generated preference information and each of the content data for trial listening stored in the content database is calculated, and content data for trial listening having high similarity is extracted from the content database. Therefore, it is possible to effectively distribute content for trial listening suitable for individual user preference. In addition, it is possible to play content data for trial listening without the setting of conditions by the user. Therefore, it is possible to improve user convenience. Further, it is possible to provide unknown content for trial listening to the user. Therefore, it is possible to provide a chance to purchase new content to the user, which is unavailable in the related art. Furthermore, a mobile phone can be used as the terminal apparatus. Therefore, there are no restrictions in place and it is possible to improve user convenience.

According to this embodiment, user preference is estimated on the basis of the usage history information of the user, and preference information is generated. Then, the similarity between the generated preference information and each of the content data for trial listening stored in the content database is calculated, and content data for trial listening having high similarity is extracted from the content database. Therefore, it is possible to effectively distribute content for trial listening suitable for individual user preference. In addition, it is possible to play content data for trial listening without the setting of conditions by the user. Therefore, it is possible to improve user convenience. Further, it is possible to provide unknown content for trial listening to the user. Therefore, it is possible to provide a chance to purchase new content to the user, which is unavailable in the related art. Furthermore, a mobile phone can be used as the terminal apparatus. Therefore, there are no restrictions in place and it is possible to improve user convenience.

In this embodiment of the invention, a group of music content for trial listening (for example, a group of a plurality of music files for trial listening) is simultaneously distributed to a portable terminal apparatus of the user by, for example, a BCMCS system. The portable terminal apparatus preferentially shows and plays one of the distributed content for trial listening that is suitable for user preference on an application. When the user is pleased with the music content, the user performs a payment process to purchase it. For example, information of “user preference” used for a trial listening application of the portable terminal apparatus to select music provided to the user is estimated from the music playing history and the music purchase history of the user.

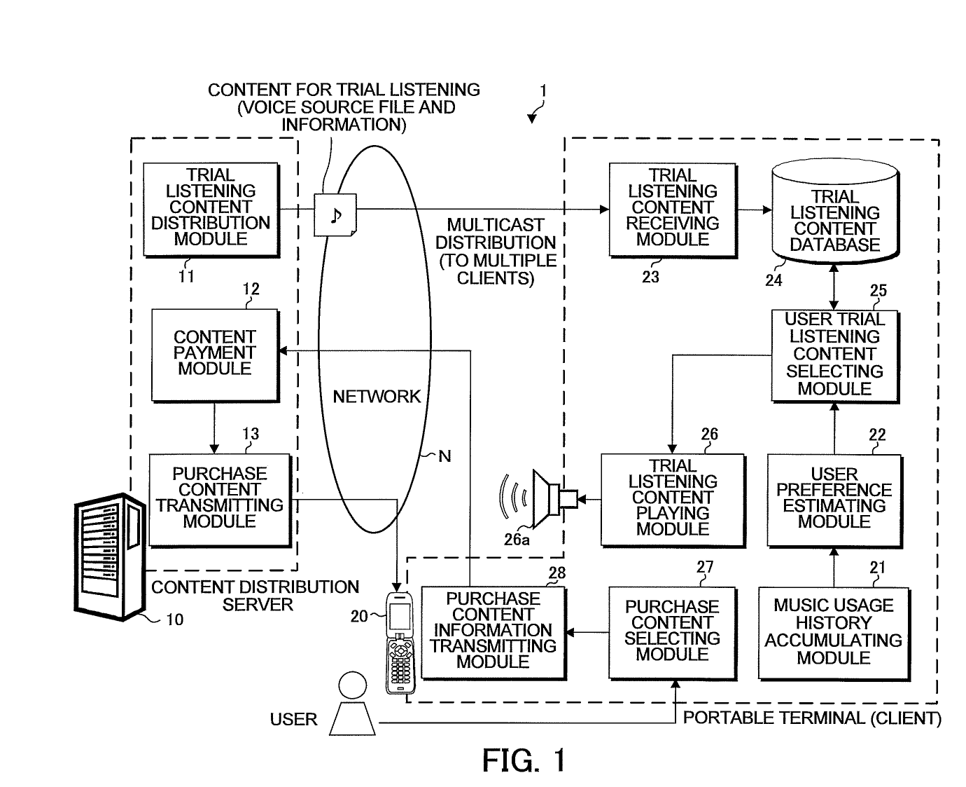

FIG. 1 is a diagram schematically illustrating the structure of a content distribution system according to this embodiment. A content distribution system 1 includes a content distribution server 10 that distributes content for trial listening and content purchased by a user, and a portable terminal apparatus 20, such as a mobile phone, used by the user. The content distribution server 10 and the portable terminal apparatus 20 are connected to each other through a network N such that they can transmit or receive information.

The content distribution server 10 includes the following three modules. A trial listening content distribution module 11 distributes content for trial listening to a user who is a recipient of services provided by the content distribution system according to this embodiment. In this embodiment, for example, it is assumed that the trial listening content distribution module distributes the same content for trial listening to a plurality of portable terminal apparatuses 20 by a BCMCS system. A content payment module 12 receives information of purchase content selected by the user from a purchase content selecting module 27 of the portable terminal apparatus 20, and performs a payment process required to purchase the content. In addition, a purchase content transmitting module 13 transmits the content paid by the content payment module 12 to the portable terminal apparatus 20 of the user who purchases the content.

The portable terminal apparatus 20 includes the following seven modules. A music usage history accumulating module 21 accumulates music usage history information of the portable terminal apparatus 20 of the user. The “music usage history” includes, for example, a purchase history, a playing history, and a function registration history (for example, music is registered as a ring tone) of music content. A user preference estimating module 22 estimates user's music preference from the history information accumulated by the music usage history accumulating module 21. Information generated by the user preference estimating module 22 is used in a process of selecting a piece of music suitable for user preference from content for trial listening. The process will be described in detail below.

A trial listening content receiving module 23 receives the content for trial listening distributed from the trial listening content distributing module 11 of the content distribution server 10, and stores the content for trial listening (a music file and meta information) in a trial listening content database 24 of the portable terminal apparatus 20. The trial listening content database 24 stores content data for trial listening received by the trial listening content receiving module 23.

A user trial listening content selecting module 25 compares the information of the content data for trial listening stored in the trial listening content database 24 with user preference information generated and output by the user preference estimating module 22 to select content data for trial listening that is suitable for the user preference. The process of the user trial listening content selecting module 25 will be described in detail below. A trial listening content playing module 26 plays the content data for trial listening selected by the user trial listening content selecting module 25. The trial listening content playing module 26 plays and outputs the content data for trial listing as music from an audio output device, such as a speaker 26a, provided in the portable terminal apparatus 20, and displays information of the played content for trial listening (for example, a title, an artist, and purchase information of content) on a display device (not shown) of the portable terminal apparatus 20.

A purchase content selecting module 27 is operated by the user to designate the content to be purchased by the user from the contents played by the trial listening content playing module 26. In addition, the trial listening content playing module 26 may perform these processes. A purchase content information transmitting module 28 transmits the information of the purchased content obtained by the purchase content selecting module 27 to the content distribution server 10. Specifically, the purchase content information transmitting module 28 transmits the information to the content payment module 12 of the content distribution server 10 through the network N.

Next, the operation of the content distribution system having the above-mentioned structure according to this embodiment will be described. The content distribution system according to this embodiment is characterized in that it extracts music information suitable for user's music preference from a large amount of contents for trial listening distributed from the content distribution server 10 to the portable terminal apparatus 20 of the user, and preferentially plays the extracted content data for trial listening using a trial listening music application of the portable terminal apparatus 20, thereby giving a change to purchase content. Specifically, the portable terminal apparatus 20 of the user stores a music usage history, estimates user's music preference from the music usage history, and extracts content data suitable for the user preference from the distributed content data for trial listening, on the basis of the user's music preference.

(Method of Estimating User Preference from Music Usage History)

In this embodiment, it is assumed that the “music usage history” includes, for example, the following information: a music playing history of the portable terminal apparatus 20 (for example, the number of playings and playing time); and the usage of music content in the portable terminal apparatus 20 (for example, music is registered as a ring tone).

It is possible to know information of portable terminal user's favorite music from the music usage history information. For example, music frequently played by the portable terminal apparatus 20 is estimated as user's favorite music. In addition, music that is registered as a ring tone in the portable terminal apparatus can be estimated as user's favorite music. The following two methods are used to extract user preference information on the basis of the above-mentioned information.

(1) Method of Extracting User Preference on the Basis of Music Meta Information Included in Playing History

Music meta information indicates, for example, an artist, a genre, and a release date of music. In this method, for example, when the user has frequently played a specific genre of music, such as “rock and roll”, it is possible to extract “rock and roll” as a user's favorite genre. In addition, it is possible to represent the user preference on the basis of a relative frequency in the playing history (for example, the appearance ratio of meta information in the entire playing history) in addition to a method of extracting one meta information item (the most frequent meta information in the playing history) as the user preference information.

(2) Method of Extracting User Preference on the Basis of Acoustic Characteristics of Music Included in Playing History

In this method, for example, when music corresponding to meta information that is extracted as information indicating the user's music preference is not included in the distributed content for trial listening, it is difficult to extract music suitable for the user preference. Therefore, when the method of extracting user preference on the basis of the acoustic characteristics of music included in the playing history is used, it is possible to extract music suitable for the user preference without depending on the meta information of music for trial listening.

For example, a technique for implementing the method (2) has been proposed in Japanese Patent Application Laid-Open No. 2003-316818 (Patent Document 7) and K. Hoashi, et al., Personalization of user profiles for content-based music retrieval based on relevance feedback, Proc of ACM Multimedia 2003 (Non-Patent Document 1). These documents disclose a method of vectorizing user preference on the basis of the acoustic characteristics of user's favorite music. Specifically, music is vectorized by tree vector quantization on the basis of MFCC extracted from user's favorite music, after which the vector of the user's favorite music is added to calculate a vector indicating the user preference.

(Method of Extracting Music from Content for Trial Listening)

In this embodiment, the following information is included in the content for trial listening (including a plurality of music pieces) distributed from the content distribution server 10: a music source file; music meta information (a title, an artist, and a genre); music characteristic vector; and music purchase information.

The information is matched with user preference information extracted by the above-mentioned method to extract music that the user can listen to. For example, when a method of using the meta information of music to extract user preference is used, it is possible to extract content for trial listening by comparing the meta information included in the user preference with the meta information of music included in content for trial listening. Specifically, when the user's favorite music genre is “rock and roll”, rock and roll music is extracted from the content for trial listening. In addition, as described above, when user preference information is extracted on the basis of a relative frequency in the playing history, a method of extracting music for trial listening from content data for trial listening on the basis of a frequency in the user preference information may be used.

When the user preference information is extracted on the basis of the acoustic characteristics of music, the following method can be used: a method of calculating similarity between a user preference vector and a feature vector of music in the content for trial listening and extracting music having high similarity. Specifically, when a user preference vector is U=(u_1, u_2, . . . , u_n) and a music acoustic vector is S=(s_1, s_2, . . . , s_n), it is possible to calculate similarity Sim(U, S) between user preference U and music S by Expression 1 given below.

Sim(U, S)=(U·S)/|U||S| [Expression 1]

(where U·S indicates the inner product of the vectors U and S. and |U| indicates the Euclidean length of the vector U).

For example, the following method can be used: a method of calculating similarity between the acoustic vectors of all music pieces included in content data for trial listening and the user preference vector and extracting the top M music pieces.

In addition, a method of integrating the meta information with the acoustic characteristics to extract music for trial listening may be used. For example, the following method may be used: a method of extracting a specific genre of music as a subset from content data for trial listening and extracting a group of music pieces having high (acoustic) similarity with user preference from the music pieces included in the subset as music pieces for trial listening.

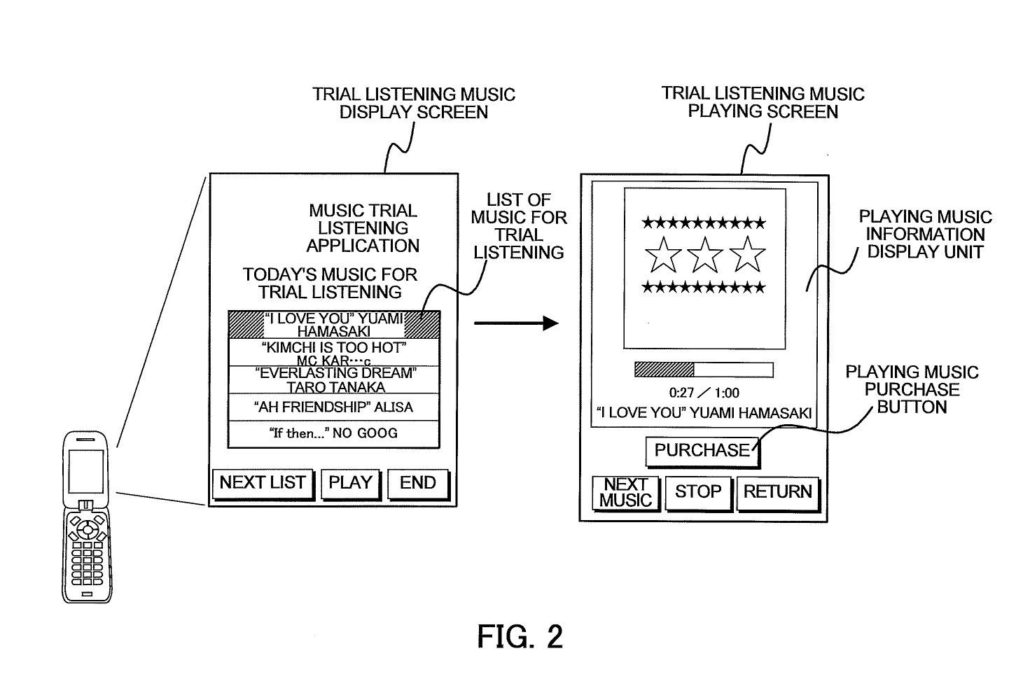

Next, an example of a screen displayed on the portable terminal apparatus 20 will be described. FIG. 2 is a diagram illustrating examples of a screen displayed on the portable terminal apparatus 20. In FIG. 2, an application screen is mainly divided into a “trial listening music display screen” and a “trial listening music playing screen”. In FIG. 2, the trial listening music display screen is shown on the left side, and the trial listening music playing screen is shown on the right side. A list of music pieces for trial listening extracted from content for trial listening by the above-mentioned method is displayed on the trial listening music display screen. Specifically, information of music for trial listening (for example, a title and an artist name) is displayed in a “trial listening music list” shown in FIG. 2. The user uses an operation key of the portable terminal to select music for trial listening that the user wants to listen to. When the selected music is played, the screen is changed to the trial listening music playing screen. In addition, a structure allowing the user to purchase content data displayed on the trial listening music display screen may be constructed.

In addition, the information of music for trial listening that is selected from the trial listening music display screen by the user and then played is displayed on the trial listening music playing screen, and a function of allowing the user to purchase the music being played (or the played music) is also displayed on the trial listening music playing screen. Specifically, a playing music information display unit displays the information of music being played (for example, a title and an artist name). When the user wants to purchase the music being played, the user clicks a “playing music purchase button” to perform a purchase process. During the purchase process, information required to purchase content (for example, an ID of music to be purchased and a user ID) is transmitted to the content payment module 12 of the content distribution server 10.

In this embodiment, a content trial listening application is installed in the portable terminal apparatus 20, but the invention is not limited thereto. For example, the content trial listening application may be installed in other terminals, such as a set top box (STB). In this case, content for trial listening is distributed through the Internet. In addition, when a trial listening content classifying module is provided, it is necessary to add, to the content trial listening application, a function of allowing the user to select a category of content for trial listening that the user wants to listen to. The function may be provided in various ways. For example, preferably, a screen for allowing the user to select a category of content may be inserted before the “trial listening music display screen”.

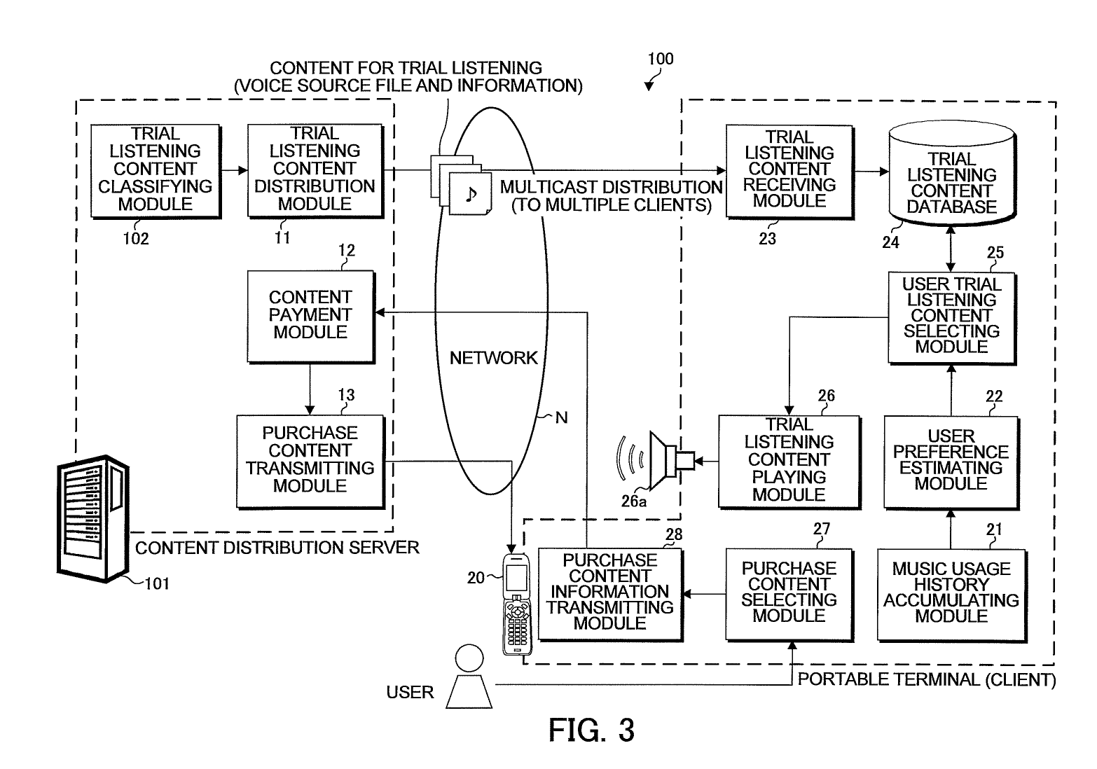

FIG. 3 is a diagram illustrating a modification of the content distribution system according to this embodiment. A content distribution system 100 differs from the content distribution system 1 shown in FIG. 1 in the structure of a content distribution server 101. The content distribution server 101 shown in FIG. 3 includes a newly added trial listening content classifying module 102. The trial listening content classifying module 102 classifies content to be distributed to each user into a plurality of categories. The classification result obtained by the trial listening content classifying module 102 is transmitted to the trial listening content distribution module 11. The trial listening content distribution module 11 distributes the plurality of classified trial listening content categories as content for trial listening to the portable terminal apparatus 20 of the user. Then, the trial listening content playing module 26 of the portable terminal apparatus 20 selects a user desired category from the distributed categories for trial listening.

The trial listening content classifying module 102 classifies content into categories as follows. For example, similar to the user preference extracting method, meta information and acoustic characteristics may be used to classify content for trial listening. First, as a method of classifying content for trial listening on the basis of the meta information, the following can be used: a method of classifying content for trial listening on the basis of each meta information according to information added to content data for trial listening (for example, music genre information). A clustering method of using the music feature vector may be considered as a method of classifying content for trial listening on the basis of the acoustic characteristics. Specifically, any of the following methods may be used: a method of calculating similarity between a predetermined cluster and a feature vector of content to be classified and classifying the content into a cluster having the highest similarity; and a known method, such as a k-means clustering method.

As described above, according to the content distribution system of this embodiment, since it is assumed that a portable terminal apparatus is used, there are no restrictions in place and it is possible to improve user convenience, as compared to the structures using a terminal for trial listening disclosed in Patent Documents 1 to 4 in the related art. In addition, in the trial listening music purchase technique using a portable terminal apparatus disclosed in, for example, Patent Documents 5 and 6, the user needs to manually select desired music for trial listening. However, in this embodiment, this structure is improved. In addition, unlike a program distribution service according to the related art, it is possible to effectively distribute music content for trial listening that is suitable for individual user preference, and thus improve user convenience. In addition, it is possible to reduce the cost of a content provider. Further, since desired content can be effectively played without the setting of conditions by the user, it is possible to greatly improve user convenience. Further, it is possible to provide unknown content for trial listening to the user. Therefore, it is possible to provide a chance to purchase content to the user, which has not been proposed in the related art.

What is claimed is:

1. A trial listening content distribution system comprising:
a terminal apparatus; and
a content distribution server,
wherein the terminal apparatus receives plural kinds of content data for trial listening from the content distribution server, and plays one of the received content data for trial listening, and
the terminal apparatus includes:
a content database that stores the plural kinds of received content data for trial listening;
a usage history information recording unit that records usage history information of a user;
a user preference estimating unit that estimates user preference on the basis of the recorded usage history information of the user, and generates preference information;
a content extracting unit that calculates similarity between the generated preference information and each of the content data for trial listening stored in the content database, and extracts content data for trial listening having high similarity from the content database; and
a content data playing unit that plays the extracted content data for trial listening.

2. The trial listening content distribution system according to claim 1,
wherein the terminal apparatus further includes:
a purchase content selecting unit that is operated by the user to generate purchase content information indicating that the user purchases one of the content data for trial listening extracted by the content extracting unit, or content corresponding to the content data for trial listening currently being played by the content data playing unit or the content data for trial listening played by the content data playing unit; and
a purchase content information transmitting unit that transmits the purchase content information to the content distribution server.

3. The trial listening content distribution system according to claim 1,
wherein the usage history information of the user includes at least one of a content purchase history, a content playing history, and a function registration history related to the setting of content playing.

4. The trial listening content distribution system according to claim 1,
wherein the content data for trial listening is music data for trial listening, and
the content extracting unit calculates the similarity between the generated preference information and each of the music data for trial listening stored in the content database on the basis of meta information added to the music data for trial listening, an amount of acoustic characteristics extracted from the music data, or a combination thereof.

5. The trial listening content distribution system according to claim 1,
wherein the content distribution server includes:
a storage unit that stores plural kinds of content data for trial listening;
a content classifying unit that classifies the stored content data for trial listening into a plurality of categories; and
a content transmitting unit that transmits the content data for trial listening classified into the plurality of categories to the terminal apparatus,
the content database stores the content data for trial listening classified into the plurality of categories and transmitted from the content distribution server, and
the content extracting unit extracts content data from one of the categories designated by the user.

6. A terminal apparatus that receives plural kinds of content data for trial listening from a content distribution server and plays one of the received content data for trial listening, comprising:
a content database that stores the plural kinds of received content data for trial listening;
a usage history information recording unit that records usage history information of a user;
a user preference estimating unit that estimates user preference on the basis of the recorded usage history information of the user, and generates preference information;
a content extracting unit that calculates similarity between the generated preference information and each of the content data for trial listening stored in the content database, and extracts content data for trial listening having high similarity from the content database; and
a content data playing unit that plays the extracted content data for trial listening.
